(19) United States
(12) Patent Application Publication
(10) Pub. No.: US 2014/0280959 A1
(43) Pub. Date: Sep. 18, 2014

(54) APPLICATION SERVER INSTANCE SELECTION BASED ON PROTOCOL LATENCY INFORMATION

(71) Applicant: Eric J. Bauer, Freehold, NJ (US)

(72) Inventor: Eric J. Bauer, Freehold, NJ (US)

(21) Appl. No.: 13/842,087

(22) Filed: Mar. 15, 2013

(51) Int. Cl. H04L 29/08

(52) U.S. Cl. CPC H04L 67/1008
USPC 709/226

(57) ABSTRACT

A capability is provided for performing application service instance selection for applications based on protocol latency information in a virtualized environment. The virtualized environment includes host computers that host virtual machines, which in turn host guest operating systems, which in turn host application server instances associated with one or more applications. The virtualized environment uses a load balancer to balance application traffic for an application across the application server instances associated with the application. The load balancer determines protocol latency information associated with protocol message exchanges between the load balancer and guest operating systems hosting the application server instances. The load balancer receives application processing requests from application clients of the application and selects between the application server instances of the application for the application processing requests based on the protocol latency information.

### TECHNICAL FIELD

The disclosure relates generally to a distributed virtual environment and, more specifically but not exclusively, to selection of application server instances in a distributed virtual environment.

### BACKGROUND

A distributed virtual environment may be used to deploy a virtual application having multiple application server instances such that application requests from clients to the application may be served using any of the multiple server instances.

### SUMMARY OF EMBODIMENTS

Various deficiencies in the prior art may be addressed by embodiments related to handling of application requests in a distributed virtual environment.

In one embodiment, an apparatus includes a processor and a memory communicatively connected to the processor. The processor is configured to receive an application processing request for an application having a plurality of application server instances associated therewith, where the application is at an application layer. The processor is configured to select one of the application server instances to which to provide the application processing request based on protocol latency information associated with the application server instances, where the protocol latency information is associated with at least one communication protocol of at least one communication layer below the application layer.

In one embodiment, a computer-readable storage medium stores instructions which, when executed by a computer, cause the computer to perform a method that includes receiving an application processing request for an application having a plurality of application server instances associated therewith where the application is at an application layer, and selecting one of the application server instances to which to provide the application processing request based on protocol latency information associated with the application server instances, where the protocol latency information is associated with at least one communication protocol of at least one communication layer below the application layer.

In one embodiment, a method includes using a processor and a memory for receiving an application processing request for an application having a plurality of application server instances associated therewith and where the application is at an application layer, and selecting one of the application server instances to which to provide the application processing request based on protocol latency information associated with the application server instances, where the protocol latency information is associated with at least one communication protocol of at least one communication layer below the application layer

### BRIEF DESCRIPTION OF THE DRAWINGS

The teachings herein can be readily understood by considering the following detailed description in conjunction with the accompanying drawings, in which:

FIG. 1 depicts an exemplary system including a virtual environment hosting applications and a load balancer for distributing application request messages of an application among application server instances of the application;

FIG. 2 depicts an exemplary embodiment of a method for selecting one of a plurality of application server instances of an application to handle an application processing request for the application;

FIG. 3 depicts an exemplary embodiment of a method for selecting one of a plurality of application server instances of an application to handle an application processing request for the application;

FIG. 4 depicts an exemplary embodiment of a method for performing application server instance selections for an application based on protocol latency measurements;

FIG. 5 depicts an exemplary embodiment of a method for measuring a protocol latency of a message exchange between a load balancer and a guest operating system hosting an application server instance; and

FIG. 6 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In general, a capability is provided for improving load balancing for application layer messages of an application at an application layer based on protocol latency information of one or more protocols at one or more communication layers below the application layer.

In at least some embodiments, a capability is provided for performing application service instance selection for an application based on protocol latency information in a virtualized environment. The virtualized environment includes host computers that host virtual machines, which in turn host guest operating systems, which in turn host application server instances associated with one or more applications. The virtualized environment uses a load balancer to balance application traffic from application clients for the application across the application server instances associated with the application. The load balancer determines protocol latency information associated with protocol message exchanges between the load balancer and the guest operating systems hosting the application server instances. The protocol message exchanges include message exchanges of one or more protocols at one or more communication layers below the application layer. The load balancer selects between the application server instances of the application for application processing requests from the application clients based on the protocol latency information associated with the guest operating systems hosting the application server instances. The load balancer propagates the application processing requests to the application server instances of the application selected by the load balancer to handle the application processing requests, respectively. The load balancer may provide various other functions as discussed below.

Various embodiments for improving load balancing for application layer messages of an application at an application layer, based on protocol latency information of one or more protocols at one or more communication layers below the application layer, may be better understood by considering the exemplary system of FIG. 1.

FIG. 1 depicts an exemplary system including a virtual environment hosting an application and a load balancer for distributing application request messages among application server instances of the application.

The exemplary system 100 includes a plurality of client devices (CDs) 110₁-110_{M} (collectively, CDs 110), a plurality of host computers (HCs) 120₁-120_{N} (collectively, HCs 120), and a load balancer (LB) 130. The CDs 110 and HCs 120 exchange messages via LB 130. The CDs 110 and HCs 120 are communicatively connected to LB 130.

The CDs 110₁-110_{M} include respective client operating systems (COSs) 112₁-112_{M} (collectively, COSs 112) hosting respective application clients (ACs) 114₁-114_{M} (collectively, ACs 114). The ACs 114 of the CDs 110 support an application that is hosted within HCs 120 (which may be the same or different applications for the ACs 114 of the CDs 110). For example, the CDs 110 may be end user devices (e.g., desktop computers, laptop computers, tablet computers, smartphones, or the like), network devices, machines for use in machine-to-machine communications, or the like.

The HCs 120₁-110_{M} include respective hypervisors 121₁-121_{M} (collectively, hypervisors 121) and respective pluralities of virtual machines (VMs) 122. For example, HC 120₁ includes a plurality of VMs 122₁₁-122_{1X} and HC 120_{N} includes a plurality of VMs 122_{N1}-122_{NY}. As depicted in FIG. 1, VMs 122 support respective guest OSs (GOSs) 124 (illustratively, VMs 122₁₁-122_{1X} of HC 120₁ support respective GOSs 124₁₁-124_{1X} and VMs 122_{N1}-122_{NY} of HC 120_{N} support respective GOSs 124_{N1}-124_{NY}). As further depicted in FIG. 1, GOSs 124 host respective application server instance (ASI) 126 of an application (illustratively, GOSs 124₁₁-124_{1X} of HC 120₁ host respective ASIs 126₁₁-126_{1X} and GOSs 124_{N1}-124_{NY} of HC 120_{N} host respective ASIs 126_{N1}-126_{NY}). The HCs 120 host one or more applications. The HCs 120 may provide a virtual environment which may be supported in any manner suitable for supporting a virtual environment (e.g., deploying HCs 120 within a single data center, deploying HCs 120 across multiple data centers, using a cloud-computing arrangement, or the like, as well as various combinations thereof).

The CDs 110 and HCs 120 may support one or more applications. For example, the ACs 114₁-114_{M} of CDs 110₁-110_{M} are application clients for respective applications (illustratively, CA 114₁ of CD 110₁ is an application client for an application denoted as APP1 while CA 114_{M} of CD 110_{M} is an application client for an application denoted as APP6). Similarly, for example, the ASIs 126 of HCs 120 are application server instances for respective applications (illustratively, GOS 124₁₁ of HC 120₁ is an application server instance for the application denoted as APP1, GOS 124_{1X} of HC 120₁ is an application server instance for an application denoted as APP4, GOS 124_{N1} of HC 120_{N} is an application server instance for the application denoted as APP6, and GOS 124_{NX} of HC 120_{N} is an application server instance for the application denoted as APP1). It will be appreciated that although a specific number of applications are given as examples (namely, applications APP1, APP2, APP4, and APP6, which implies support of at least six applications), fewer or more applications may be supported.

The CDs 110 and HCs 120 may support various communication capabilities adapted for use in supporting application layer communications between CDs 110 and HCs 120 for the one or more applications supported by the CDs 110 and HCs 120. The CDs 110 and HCs 120 may support various communication stacks, communication protocols, and the like. More specifically, the COSs 112 of the CDs 110 and the GOSs 124 of the VMs 122 of HCs 120 may support communications capabilities which may or may not be used to transport application layer communications between the ACs 114 of the CDs 110 and the ASIs 126 of the HCs 120. For example, the COSs 112 of the CDs 110 and the GOSs 124 of the VMs 122 of HCs 120 may support communications at various communication layers of the Open Systems Interconnection (OSI) model that are below the application layer; namely, at one or more of the presentation layer (e.g., using Multipurpose Internet Mail Extensions (MIME), External Data Representation (EDR), or any other suitable presentation layer protocols or communication capabilities), the session layer (e.g., Real-Time Transport Protocol (RTP), Point-To-Point Tunneling Protocol (PPTP), or any other suitable session layer protocols or communication capabilities), the transport layer (e.g., Transmission Control Protocol (TCP), User Datagram Protocol (UDP), Stream Control Transmission Protocol (SCTP), or any other suitable transport layer protocols or communication capabilities), the network layer (e.g., Internet Protocol (IP), Internet Control Message Protocol (ICMP), or any other suitable network layer protocols or communication capabilities), the data link layer (e.g., Generic Framing Procedure (GFP), Asynchronous Transfer Mode (ATM), or any other suitable data link layer protocols or communication capabilities), or the physical layer (e.g., Synchronous Optical Network (SON), Passive Optical Network (PON), or any other suitable physical layer protocols or communication capabilities). Thus, the COSs 112 of the CDs 110 and the GOSs 124 of the VMs 122 of HCs 120 may be configured to handle various types of protocol message exchanges for protocol messages which may be exchanged at the various communication layers below the application layer (e.g., MIME messages, EDR messages, RTP messages, PPTP messages, TCP messages, UDP messages, SCTP messages, IP messages, ICMP messages, GFP messages, ATM messages, SON messages, PON messages, or any other suitable types of protocol messages).

The CDs 110 and HCs 120 support use by the CDs 110 of applications hosted by HCs 120. The ACs 112 of the CDs 110 are configured to initiate application processing requests for processing by the respective applications supported by the ACs 112. The ACs 112 of the CDs 110 are configured to propagate the application processing requests for processing by application servers of the respective applications for which the application processing requests are initiated. As described above, the application servers for the respective applications are implemented using respective pluralities of ASIs 126. The ASIs 126 of the HCs 120 are configured to receive application processing requests associated with the respective applications supported by the ASIs 126. For example, AC 114₁ associated with APP1 is configured to initiate application processing requests for APP1, where such application processing requests will be served by the ASIs 126 of HCs 120 which are associated with APP1 (illustratively, ASI 126₁₁ of HC 120₁ and ASI 126_{NY} of HC 120_{N}, as well as any other ASIs 126 of the HCs 120 that support APP1). Similarly, for example, AC 114_{N} associated with APP6 is configured to initiate application processing requests for APP6, where such application processing requests will be served by the ASIs 126 of HCs 120 which are associated with APP6 (illustratively, ASI 126_{N1} of HC 120_{N}, as well as any other ASIs 126 of the HCs 120 that support APP6). Therefore, the HCs 120 provide a virtual environment for applications hosted by the GOSs 124, thereby enabling the processing of application requests from ACs 114 of CDs 110 to be distributed across multiple ASIs 126 in a manner that is transparent to the CDs 110.

The LB 130 facilitates communications between the CDs 110 and the HCs 120, which may include communications at various communication layers which include, among others, the application layer and one or more communication layers below the application layer. The LB 130 may be implemented in any suitable manner. For example, the LB 130 may be implemented directly on hardware (e.g., as a one or more load balancer devices including one or more dedicated processors and one or more memories), using a virtualized implementation (e.g., using one or more virtual machines hosted in one or more data centers), or the like. For example, the LB 130 may be a physical server deployed in a dedicated data center. For example, the LB 130 may be a load balancer instance hosted on one or more virtual machines in a virtualized environment (e.g., a cloud-based data center). The LB 130 may be implemented and deployed in any other manner suitable for enabling LB 130 to provide the various functions depicted and described herein. It will be appreciated that the implementation of LB 130 may depend on the manner in which HCs 120 are implemented.

The LB 130 may support protocol message exchanges between the COSs 112 of the CDs 110 and the GOSs 124 of the VMs 122 of HCs 120 for one or more communication protocols operating at one or more communication layers below the application layer. The LB 130 also may support protocol message exchanges between LB 130 and the GOSs 124 of the VMs 122 of HCs 120 for one or more communication protocols operating at one or more communication layers below the application layer (e.g., which may be performed by LB 130 in response to interaction by LB 130 with associated CDs 110 or on behalf of CDs 110, for various types of functions provided by LB 130 which may require communications between LB 130 and GOSs 124 independent of communications between LB 130 and CDs 110, or the like, as well as various combinations thereof). For example, within the context of a TCP handshake between a COS 112 of a CD 110 and a GOS 124 of a VM 122, the LB 130 may receive a SYN message from the COS 112 of the CD 110, propagate a SYN message to the GOS 124 of the VM 122, receive a SYN+ACK message from the GOS 124 of the VM 122, propagate the SYN+ACK message to the COS 112 of the CD 110, receive an ACK message from the COS 112 of the CD 110, and propagate an ACK message the GOS 124 of the VM 122. Similarly, for example, LB 130 may be configured to support message exchanges between a COS 112 of a CD 110 and a GOS 124 of a VM 122 for UDP. The typical operation of protocol message exchanges for these and other communication protocols operating at communication layers below the application layer will be understood by one skilled in the art.

The LB 130 also facilitates application layer message exchanges between the ACs 114 of the CDs 110 and the ASIs 126 of the VMs 122 of HCs 120. The LB 130 receives an application processing request from an AC 114 of a CD 110, determines an application with which the application processing request is associated, identifies available ASIs 116 configured to handle the application processing request (i.e., ASIs 116 supporting the identified application of the application processing request), selects one of the available ASIs 116 configured to handle the application processing request, and propagates the application processing request to the selected one of the available ASIs 116 configured to handle the application processing request. The selected one of the available ASIs 116 configured to handle the application processing request receives the application processing request, processes the application processing request in order to determine a corresponding application processing response, and propagates the application processing response toward the AC 114 of the CD 110 from which the application processing request originated. The application processing response may be routed to the AC 114 of the CD 110 indirectly via the LB 130 or directly without traversing the LB 130. The LB 130 also may support application layer message exchanges between LB 130 and the ACs 114 of the CDs 110 (e.g., which may be performed by LB 130 in response to interaction by LB 130 with associated GOSs 124 or on behalf of GOSs 124, for various types of functions provided by LB 130 which may require application layer message exchanges between LB 130 and ACs 114 of CDs 110 independent of communications between LB 130 and GOSs 124, or the like, as well as various combinations thereof). The LB 130 also may support application layer message exchanges between LB 130 and the GOSs 124 of the VMs 122 of HCs 120 (e.g., which may be performed by LB 130 in response to interaction by LB 130 with associated CDs 110 or on behalf of CDs 110, for various types of functions provided by LB 130 which may require application layer message exchanges between LB 130 and GOSs 124 independent of communications between LB 130 and CDs 110, or the like, as well as various combinations thereof).

The LB 130 may be configured to select between a plurality of available ASIs 126 of an application based on protocol latency information associated with the GOSs 124 that host the available ASIs 126 for the application, which may include direct use of protocol latency information associated with the GOSs 124 or use of performance information determined or inferred based on protocol latency information associated with the GOSs 124.

The LB 130 may be configured to determine protocol latency information for GOSs 124 which host ASIs 126.

The LB 130 may be configured to determine protocol latency information for a GOS 124 at one or more levels of granularity. The one or more levels of granularity of protocol latency information for a GOS 124 may be based on a fundamental measure of a protocol latency measurement of a protocol message exchange between the LB 130 and the GOS 124; namely, one or more such protocol latency measurements for the GOS 124 may be used to determine the protocol latency information for the GOS 124 and, further, for one or more elements associated with the GOS 124 (e.g., the ASI 126 hosted by the GOS 124, the VM 122 hosting the GOS 124, the HC 120 hosting the GOS 124, or the like, as well as various combinations thereof).

The LB 130 may be configured to determine protocol latency information for a GOS 124 by performing one or more protocol latency measurements, to determine one or more protocol latency values, for one or more protocol message exchange types of one or more communication protocols of one or more communication layers below the application layer.

The LB 130 may be configured to determine protocol latency information for a GOS 124 by determining one or more protocol latency values for one or more communication protocols of one or more communication layers below the application layer. The LB 130 may be configured to determine a protocol latency value for a communication protocol based on protocol latency information for one or more protocol message exchange types of the communication protocol.

The LB 130 may be configured to determine protocol latency information for a GOS 124 by determining one or more protocol latency values for one or more communication layers below the application layer. The LB 130 may be configured to determine a protocol latency value for a communication layer based on protocol latency information for one or more communication protocols (which, as noted above, may in turn be determined based on protocol latency information for one or more protocol message exchange types of the communication protocol).

The LB 130 may be configured to determine various types of protocol latency values at various levels of granularity. For example, LB 130 may be configured to determine a most recent protocol latency value, a maximum protocol latency value, an average protocol latency value, or the like, as well as various combinations thereof. For example, LB 130 may be configured to determine a most recent protocol latency value for a specific type of protocol message exchange (e.g., the most recent protocol latency measurement for a protocol message exchange of that protocol message exchange type, for a communication protocol (e.g., the most recent protocol latency measurement of any protocol message exchanges of any protocol message exchange types of the communication protocol), for a communication layer (e.g., the most recent protocol latency measurement of any protocol message exchanges of any protocol message exchange types of any communication protocols of the communication layer), or the like. For example, LB 130 may be configured to determine a maximum protocol latency value for a specific type of protocol message exchange (e.g., the maximum protocol latency measurement from the last x protocol message exchanges of that protocol message exchange type, for a communication protocol (e.g., the maximum protocol latency measurement from the last x protocol message exchanges of any protocol message exchange types of the communication protocol), for a communication layer (e.g., the maximum protocol latency measurement from the last x protocol message exchanges of any protocol message exchange types of any communication protocols of the communication layer), or the like. For example, LB 130 may be configured to determine an average protocol latency value for a specific type of protocol message exchange (e.g., an average of the last x protocol latency measures of that protocol message exchange type, for a communication protocol (e.g., an average of the last x protocol latency measures of any protocol message exchange types of the communication protocol), for a communication layer (e.g., an average of the last x protocol latency measures of any protocol message exchange types of any communication protocols of the communication layer), or the like.

Thus, LB 130 may be configured to determine protocol latency measurements at the protocol message exchange level and process the protocol latency measurements to determine various types of protocol latency information at various levels of granularity.

Thus, the protocol latency information for a given GOS 124 may include various types of information, which may include or may be based on one or more protocol latency measurements for one or more protocol message exchanges of one or more protocol message exchange types of one or more communication protocols of one or more communication layers below the application layer used by the ASI 126 of the given GOS 124.

The protocol latency information associated with GOSs 124 that host ASIs 126 for an application may be used as a proxy for (1) the associated performance of the ASIs 126 for the application or (2) the associated performance of elements that support the ASIs 126 for the application (e.g., the GOSs 124 that host the ASIs 126, the VMs 122 that host the GOSs 124 that host the ASIs 126, the HCs 120 that host the VMs 122 that host the GOSs 124 that host the ASIs 126, or the like). In other words, although protocol latency information associated with GOSs 124 that host ASIs 126 may not be a direct measure of the performance of the ASIs 126 or elements that support the ASIs 126, the protocol latency information associated with the GOSs 124 that host the ASIs 126 may be indicative of (1) the performance of the ASIs 126 or (2) the performance of elements that support the ASIs 126 and, thus, of the performance of ASIs 126. Thus, protocol latency information associated with GOSs 124 that host ASIs 126 also may be considered to be associated with the ASIs 126 (as well as with the VMs 122 which host the GOSs 124 that host the ASIs 126). In at least some embodiments, LB 130 may use such protocol latency information associated with GOSs 124 to select between available ASIs 126 of an application for an application processing request.

The LB 130 may be configured to determine or infer GOS performance information indicative of performance of GOSs 124 based on protocol latency information associated with the GOSs 124. The GOS performance information of a GOS 124 may include any suitable types of information which may be determined or inferred based on the protocol latency measurements associated with the GOS 124, such as an expected GOS processing response time of the GOS 124, an indication as to whether or not the GOS 124 may be experiencing a condition which may impact the ASI processing response times of the ASI 126 hosted by the GOS 124 (e.g., whether or not the GOS 124 may have stalled, whether or not the GOS 124 may have failed, or the like), or the like, as well as various combinations thereof. It will be appreciated that various other types of GOS performance information may be determined or inferred for a GOS 124 based on protocol latency measurements associated with the GOS 124. In at least some embodiments, LB 130 may use such GOS performance information to select between available ASIs 126 of an application for an application processing request.

The LB 130 may be configured to determine or infer ASI performance information indicative of performance of ASIs 126 based on protocol latency information associated with the GOSs 124. The ASI performance information of an ASI 126 may include any suitable types of information, such as an expected ASI processing response time of the ASI 126, an indication as to whether or not the ASI 126 may be experiencing a condition which may impact the ASI processing response time of the ASI 126 (e.g., whether or not the ASI 126 may have stalled, whether or not the ASI 126 may have failed, or the like), or the like, as well as various combinations thereof. For example, LB 130 may be configured to determine or infer that protocol latency information for a GOS 124 corresponds to an application processing response time for the ASI 126 hosted by the GOS 124 (e.g., the application processing response time for the ASI 126 hosted by the GOS 124 may be computed based on a protocol latency value for the GOS 124 using a function which correlates these two values). For example, LB 130 may be configured to determine or infer that an ASI 126 has stalled based on a determination that a protocol latency value for a GOS 124 hosting the ASI 126 exceeds a threshold. For example, LB 130 may be configured to determine or infer that an ASI 126 has failed based on a determination that protocol latency value for a GOS 124 hosting the ASI 126 exceeds a threshold (e.g., a threshold greater than a threshold used to determine or infer that the ASI 126 has stalled). It will be appreciated that various other types of ASI performance information may be determined or inferred for an ASI 126 based on protocol latency information associated with a GOS 124 hosting the ASI 126. In at least some embodiments, LB 130 may use such ASI performance information to select between available ASIs 126 of an application for an application processing request.

The LB 130 may be configured to determine or infer VM performance information indicative of performance of VMs 122 based on the protocol latency information associated with the GOSs 124 hosted by the VMs 122. The VM performance information of a VM 122 may include any suitable types of information, such as an expected VM response time of the VM 122, an indication as to whether or not the VM 122 may be experiencing a condition which may impact the ASI processing response times of the ASI 126 hosted by the VM 122 (e.g., whether or not the VM 122 may have stalled (e.g., such as where the associated hypervisor 121 does not run the VM 122 because it is giving one or more other VMs 122 time to run on its CPU), whether or not the VM 122 may have failed, or the like), or the like, as well as various combinations thereof. For example, LB 130 may be configured to determine or infer that protocol latency information for a GOS 124 corresponds to a response time for the VM 122 that is hosting the GOS 124 (e.g., the response time for the VM 122 hosting the GOS 124 may be computed based on protocol latency value for the GOS 124 using a function which correlates these two values). For example, LB 130 may be configured to determine or infer that a VM 122 has stalled based on a determination that a protocol latency value for the GOS 124 hosted by the VM 122 exceeds a threshold. For example, LB 130 may be configured to determine or infer that a VM 122 has failed based on a determination that a protocol latency value for the GOS 124 hosted by the VM 122 exceeds a threshold (e.g., a threshold greater than a threshold used to determine or infer that the VM 122 has stalled). It will be appreciated that various other types of VM performance information may be determined or inferred for a VM 122 based on protocol latency information associated with a GOS 124 hosted on the VM 122. In at least some embodiments, LB 130 may use such VM performance information to select between available ASIs 126 of an application for an application processing request.

The LB 130 may be configured to determine or infer HC performance information indicative of performance of HCs 120 based on the protocol latency information associated with the GOSs 124 of the VMs 122 hosted by the HCs 120, respectively. The HC performance information for an HC 120 may include any suitable types of information, such as an average processing response time of the VMs 122 hosted by HCs 120, a maximum processing response time among the VMs 122 hosted by HCs 120, or the like, as well as various combinations thereof. It will be appreciated that various other types of HC performance information may be determined or inferred for an HC 120 based on protocol latency information associated with GOS 124 hosted on some or all of the VMs 122 hosted by the HC 120. In at least some embodiments, LB 130 may use such HC performance information to select between available ASIs 126 of an application for an application processing request.

The LB 130 may be configured to determine or infer various other types of performance information based on protocol latency information associated with GOSs 124, protocol latency information associated with elements associated with GOSs 124 (e.g., associated VMs 122, HCs 120, or the like), performance information associated with GOSs 124, performance information associated with elements associated with GOSs 124 (e.g., associated ASIs 126, VMs 122, HCs 120, or the like), or the like, as well as various combinations thereof. For example, LB 130 may be configured to determine or infer VM performance information of a VM 122 based on ASI performance information of an ASI 126 hosted by the VM 122, determine or infer HC performance information of an HC 120 based on VM performance information of some or all of the VMs 122 hosted by the HC 120, or the like, as well as various combinations thereof.

The LB 130 may be configured to select between a plurality of available ASIs 126 for an application using the protocol latency information directly, using performance information determined or inferred from the protocol latency information (e.g., one or more of GOS performance information, ASI performance information, VM performance information, HC performance information, or the like, as well as various combinations thereof), or the like, as well as various combinations thereof.

For example, where CD 110₁ sends an application processing request for APP1 and network layer protocol latency information for GOS 124₁₁ (hosting ASI 126₁₁ on HC 120₁) and GOS 124_{NY} (hosting ASI 126_{NY} on HC 120_{N}) indicates average network layer protocol latency values of 0.121 second and 0.219 seconds, respectively, LB 130 may select ASI 126₁₁ rather than ASI 126_{NY} due to the smaller average network layer protocol latency value associated with ASI 126₁₁. For example, the network layer protocol latency information may be based on latency response measurements for IP packet exchanges between LB 130 and the GOSs 124₁₁ and 124_{NY}, respectively.

For example, where CD 110₁ sends an application processing request for APP1 and transport layer protocol latency information for GOS 124₁₁ (hosting ASI 126₁₁ on HC 120₁) and GOS 124_{NY} (hosting ASI 126_{NY} on HC 120_{N}) indicates average transport layer protocol latency values of 0.161 second and 0.145 seconds, respectively, LB 130 may select ASI 126_{NY} rather than ASI 126₁₁ due to the smaller average transport layer protocol latency value associated with ASI 126_{NY}. For example, the transport layer protocol latency information may be based on latency response measurements for TCP message exchanges between LB 130 and the respective GOSs 124₁₁ and 124_{NY} (e.g., latency between sending of TCP SYN messages by LB 130 and receipt of corresponding TCP SYN+ACK messages by LB 130).

For example, where CD 110₁ sends an application processing request for APP1 and protocol latency information for GOS 124₁₁ (hosting ASI 126₁₁ on HC 120₁) and GOS 124_{NY} (hosting ASI 126_{NY} on HC 120_{N}) indicates average protocol latency values of 0.211 second and 0.246 seconds, respectively, LB 130 may select ASI 126₁₁ rather than ASI 126_{NY} due to the smaller average protocol latency value associated with ASI 126₁₁. For example, the protocol latency information may be based on latency response measurements for IP message exchanges, TCP message exchanges, and RTP message exchanges between LB 130 and respective GOSs 124₁₁ and 124_{NY}.

For example, where CD 110₁ sends an application processing request for APP1 and ASI performance information for ASI 126₁₁ and ASI 126_{NY} indicates that ASI 126₁₁ may be experiencing a stall condition (e.g., as determined or inferred based on network layer protocol latency information for GOS 124₁₁), LB 130 may select ASI 126_{NY} rather than ASI 126₁₁ due to the potential stall condition associated with ASI 126₁₁.

For example, where CD 110₁ sends an application processing request for APP1 and protocol latency information for GOS 124₁₁ (hosting ASI 126₁₁ on HC 120₁) and GOS 124_{NY} (hosting ASI 126_{NY} on HC 120_{N}) indicates respective maximum protocol latency values for GOS 124₁₁ and GOS 124_{NY} that are substantially the same or within a particular threshold (e.g., range) of each other, LB 130 may then use HC performance information indicative of performance of HC 120₁ and HC 120_{N} in order to select between ASI 126₁₁ and ASI 126_{NY} for handling of the application processing request for APP1. For example, if HC performance information for HC 120₁ and HC 120_{N} indicates that the average GOS response time for GOSs 124₁ hosted by VMs 122₁ of HC 120₁ is 0.186 seconds whereas the average GOS response time for GOSs 124_{N} hosted by VMs 122_{N} of HC 120_{N} is 0.316 seconds, LB 130 may select ASI 126₁₁ rather than ASI 126_{NY} due to the smaller the average GOS response time for GOSs 124₁ hosted by VMs 122₁ of HC 120₁.

It will be appreciated that the foregoing examples merely represent a few of the various ways in which various types of performance information may be used by LB 130 to select between ASIs 126 of an application for an application processing request directed to the application.

As described herein, various types of performance information that may be used to select between ASIs 126 of an application for an application processing request directed to the application may be directly or indirectly based on the protocol latency measurements associated with the GOSs 124 that host the ASIs 126. As discussed above, a protocol latency measurement for a GOS 124 is a measure of the roundtrip latency for a protocol message exchange between the LB 130 and the GOS 124 (namely, the difference between a time at which LB 130 sends a protocol message to GOS 124 and a time at which LB 130 receives a corresponding protocol response message from the GOS 124).

The LB 130 may be configured to initiate measurement of the protocol latency of message exchanges between the LB 130 and GOS 124 at various times or on various time scales. In at least some embodiments, for example, LB 130 measures protocol latency for a GOS 124 at each protocol message exchange between the LB 130 and the GOS 124 (which may be for one or more protocol message exchange types of one or more communication protocols of one or more communication layers below the application layer). However, it will be appreciated that, in at least some contexts, measurement of protocol latency on this scale may be unsustainable or undesirable (e.g., due to processing overhead associated with making and tracking such measurements, memory overhead associated with storing the large volume of protocol latency information, or the like). Accordingly, in at least some embodiments, LB 130 measures protocol latency for a GOS 124 for a subset of protocol message exchanges between the LB 130 and the GOS 124 (e.g., periodically, in response to one or more events or conditions, or the like, as well as various combinations thereof). In at least some embodiments, LB 130 measures protocol latency for a GOS 124 periodically, where the periodicity may be determined temporally (e.g., once every 10 seconds, once every minute, or the like), based on numbers of protocol message exchanges by the LB 130 for (e.g., at every N-th protocol message exchange between LB 130 and the GOS 124, where N may be 10, 100, 10,000, or any other suitable number), or the like, as well as various combinations thereof. In at least some embodiments, in which protocol latency is measured periodically, the frequency with which protocol latency is measured may be dynamically adjusted by LB 130 (e.g., as determined by LB 130, by LB 130 under the control of a management system, or the like). In at least some embodiments, protocol latency measurements may be performed using statistical sampling (e.g., measuring every N-th sample, such as 1 in 1000, 1 in 10,000, or the like. It will be appreciated that, given that protocol latency may be measured at various levels of granularity, control over the frequency with which LB 130 measures protocol latency also may be provided by LB 130 at various levels of granularity (e.g., using different protocol latency measurement control parameters for different protocol message exchange types of one or more communication protocols, using different protocol latency measurement control parameters for protocol message exchanges of different communication protocols of one or more communication layers below the application layer, using different protocol latency measurement control parameters for protocol message exchanges of different communication layers below the application layer, or the like, as well as various combinations thereof).

The LB 130 may be configured to compute the protocol latency of a message exchange between the LB 130 and a GOS 124 using one or more protocol latency measurement techniques. For example, LB 130 may determine a send time at which a protocol message (e.g., a TCP SYN message) is sent from LB 130 toward the GOS 124, determine a receive time at which the corresponding protocol response message (e.g., a TCP SYN+ACK message) is received at LB 130 from the GOS 124, and determine the protocol latency of the message exchange as a difference between the receive time and the send time. For example, LB 130 may start a local timer when a protocol message (e.g., a TCP SYN message) is sent from LB 130 toward the GOS 124 and stop the local timer when a corresponding protocol response message (e.g., a TCP SYN+ACK message) is received at LB 130 from the GOS 124. For example, LB 130 may utilize time stamps within the protocol messages of the protocol message exchange in order to determine the roundtrip latency for the protocol message exchange. It will be appreciated that, given that protocol latency may be measured at various levels of granularity, control over the manner with which LB 130 measures protocol latency also may be provided by LB 130 at various levels of granularity (e.g., using the same protocol latency measurement technique for all protocol message exchanges of the one or more protocol message exchange types for which LB 130 measures protocol latency, using different protocol latency measurement techniques for different protocol message exchange types of one or more communication protocols, using different protocol latency measurement techniques for protocol message exchanges of different communication protocols of one or more communication layers below the application layer, using different protocol latency measurement techniques for protocol message exchanges of different communication layers below the application layer, or the like, as well as various combinations thereof).

The LB 130 may be configured to provide or support various other functions in order to select between available ASIs 126 of an application based on protocol latency information associated with the GOSs 124 that host the available ASIs 126 for the application.

As depicted in FIG. 1, LB 130 may be configured to provide various functions discussed above. The LB 130 includes a processor 132 and a memory 133 communicatively connected to the processor 132. The memory 133 stores programs 134 which may be retrieved from memory 133 by processor 132 and executed by processor 132 in order to provide various functions of LB 130 as discussed herein (e.g., load balancing functions, ASI selection functions, or the like, as well as various combinations thereof). The memory 133 also stores performance information 135 which may be used by programs 134 to provide various functions of LB 130 as discussed herein. The performance information 135 may include various types of performance information as discussed herein (e.g., protocol latency measurements for GOSs 124, protocol latency information associated with elements supporting ASIs 126 (e.g., GOSs 124, VMs, 122, HC 120, or the like), ASI performance information of ASIs 126, GOS performance information of GOSs 124, VM performance information of VMs 122, HC performance information of HCs 120, or the like, as well as various combinations thereof).

FIG. 2 depicts an exemplary embodiment of a method for selecting one of a plurality of application server instances of an application to handle an application processing request for the application. It will be appreciated that, although primarily depicted and described herein as being performed serially, at least a portion of the steps of method 200 may be performed contemporaneously or in a different order than presented in FIG. 2. At step 201, method 200 begins. At step 210, an application processing request, associated with an application having multiple application server instances associated therewith, is received. At step 220, one of the application server instances is selected to handle the application processing request based on protocol latency information associated with the application server instances of the application. At step 299, method 200 ends. It will be appreciated that method 200 of FIG. 2 may be better understood when read in conjunction with FIG. 1.

FIG. 3 depicts an exemplary embodiment of a method for selecting one of a plurality of application server instances of an application to handle an application processing request of an application client of the application. It will be appreciated that, although primarily depicted and described herein as being performed serially, at least a portion of the steps of method 300 may be performed contemporaneously or in a different order than presented in FIG. 3. At step 301, method 300 begins. At step 310, an application processing request associated with an application is received. At step 320, the application of the application processing request is identified. At step 330, a plurality of application server instances of the application are identified. At step 340, protocol latency information associated with the application server instances is obtained. At step 350, one of the application server instances is selected to handle the application processing request based on the protocol latency information associated with the application server instances of the application. At step 360, the application processing request is propagated toward the selected one of the application server instances of the application. At step 399, method 300 ends. It will be appreciated that method 300 of FIG. 3 may be better understood when read in conjunction with FIG. 1.

FIG. 4 depicts an exemplary embodiment of a method for performing application server instance selections for an application based on protocol latency measurements. It will be appreciated that, although primarily depicted and described herein as being performed serially, at least a portion of the steps of method 400 may be performed contemporaneously or in a different order than presented in FIG. 4. At step 401, method 400 begins. At step 410, protocol latency measurements, for protocol message exchanges between a load balancer and guest operating systems hosting application server instances of the application, are determined. An exemplary embodiment of a method for measuring protocol latency of a message exchange between a load balancer and a guest operating system hosting an application server instance is depicted and described with respect to FIG. 5. At step 420, application server instance selections are performed at the load balancer based on the protocol latency measurements. At step 499, method 400 ends. It will be appreciated that method 400 of FIG. 4 may be better understood when read in conjunction with FIG. 1.

FIG. 5 depicts an exemplary embodiment of a method for measuring a protocol latency of a message exchange between a load balancer and a guest operating system hosting an application server instance. It will be appreciated that, although primarily depicted and described herein as being performed serially, at least a portion of the steps of method 500 may be performed contemporaneously or in a different order than presented in FIG. 5. At step 501, method 500 begins. At step 510, a determination is made to perform a protocol latency measurement for the guest operating system (e.g., x seconds have passed since the last measurement, N network layer protocol message exchanges have been performed since the last measurement, an instruction to perform a measurement has been received, or the like). At step 520, a time associated with propagation of a protocol message from the load balancer toward the guest operating system is determined (e.g., a time at which a TCP SYN is sent where TCP is used as the protocol). At step 530, a time associated with receipt of an associated protocol response message at the load balancer from the guest operating system is determined (e.g., a time at which a corresponding TCP SYN+ACK is received where TCP is used as the r protocol). At step 540, the protocol latency measure for the guest operating system (which also may be used as a proxy for performance of the application server instance) is determined as a difference between the time associated with receipt of the associated protocol response message at the load balancer from the guest operating system and the time associated with propagation of the protocol message from the load balancer toward the guest operating system. At step 599, method 500 ends. It will be appreciated that although depicted and described as ending, the determined protocol latency measure for the guest operating system may be used (alone or in combination with one or more other protocol latency measures for the guest operating system or other guest operating systems) to determine additional types of performance information (e.g., protocol performance information, guest operating system performance information, application server instance performance information, virtual machine performance information, or the like, as well as various combinations thereof). It will be appreciated that method 500 of FIG. 5 may be better understood when read in conjunction with FIG. 1.

It will be appreciated that, although primarily depicted and described with respect to exemplary methods 200, 300, 400, and 500 of FIG. 2, FIG. 3, FIG. 4, and FIG. 5, respectively, the various functions disclosed herein as being performed by the LB 130 of FIG. 1 may be organized in various other ways to provide various other methods which may be invoked to provide such functions.

It will be appreciated that, although primarily depicted and described with respect to embodiments in which the application layer of the application and the one or more communication layers below the application layer are defined based on the OSI model of communication layers, the application layer of the application and the one or more communication layers below the application layer may be defined based on any other suitable type of communication layer models (e.g., the Internet Protocol suite or any other suitable type(s) of communication layer models).

It will be appreciated that, although primarily depicted and described with respect to embodiments in which protocol latency measurements are performed for a GOS based on protocol message exchanges of one or more communication protocols that support an application running on the GOS, in at least some embodiments protocol latency measurements are performed for a GOS based on protocol message exchanges that are independent of an application running on the GOS. In at least some embodiments, for example, protocol latency measurements for a GOS may be performed based on PING messages (e.g., ICMP PING or any other suitable type of PING message). The PING messages may be sent from the load balancer to the GOS and associated PING responses to the PING messages may be received and processed by the load balancer in any suitable manner (e.g., as depicted and described herein with respect to embodiments in which the protocol message exchanges are related to one or more communication protocols that support an application running on the GOS, such as by determining protocol latency information, determining performance information, or the like, as well as various combinations thereof). It will be appreciated that, although primarily depicted and described with respect to embodiments in which application server instance selection for an application is provided within a specific type of virtual environment, embodiments of application server instance selection for an application may be provided within or using various other types of virtual environments. For example, the HCs 120 may be implemented directly on hardware (e.g., as a one or more server devices, including one or more dedicated processors and one or more memories, which may be deployed within a network, within one or more data centers, or the like, as well as various combinations thereof), using one or more VMs hosted in one or more data centers, or the like. Similarly, for example, the LB 130 may be implemented directly on hardware (e.g., as a one or more server devices, including one or more dedicated processors and one or more memories, which may be deployed within a network, within one or more data centers, or the like, as well as various combinations thereof), using one or more VMs hosted in one or more data centers, or the like. Thus, it will be appreciated that application server instance selection may be supported within various types of virtualized environments.

It will be appreciated that, although primarily depicted and described with respect to environments in which application server instance selection is performed for application server instances on guest OSs, in at least some embodiments application server instance selection may be performed for application server instances on any other suitable types of OSs and, thus, that references herein to guest OSs may be read more generally as references to OSs.

It will be appreciated that, although primarily depicted and described with respect to embodiments in which application server instance selection for an application is provided within a virtualized environment, embodiments of application server instance selection for an application may be provided in various other types of environments (e.g., to select between physical servers where multiple physical servers are deployed to provide an application or service, or the like).

FIG. 6 depicts a high-level block diagram of a computer suitable for use in performing functions described herein.

The computer 600 includes a processor 602 (e.g., a central processing unit (CPU) or other suitable processor(s)) and a memory 604 (e.g., random access memory (RAM), read only memory (ROM), and the like).

The computer 600 also may include a cooperating module/process 505. The cooperating process 605 can be loaded into memory 604 and executed by the processor 602 to implement functions as discussed herein and, thus, cooperating process 605 (including associated data structures) can be stored on a computer readable storage medium, e.g., RAM memory, magnetic or optical drive or diskette, and the like.

The computer 600 also may include one or more input/output devices 606 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 600 depicted in FIG. 6 provides a general architecture and functionality suitable for implementing functional elements described herein or portions of functional elements described herein. For example, computer 600 provides a general architecture and functionality suitable for implementing a CD 110, a portion of a CD 110, an HC 120, a portion of an HC 120, LB 130, a portion of LB 130, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or” unless otherwise indicated (e.g., “or else” or “or in the alternative”).

It will be appreciated that, while the foregoing is directed to various embodiments of features present herein, other and further embodiments may be devised without departing from the basic scope thereof.

What is claimed is:

1. An apparatus, comprising:
a processor and a memory communicatively connected to the processor, the processor configured to:
receive an application processing request for an application having a plurality of application server instances associated therewith, wherein the application is at an application layer; and
select one of the application server instances to which to provide the application processing request based on protocol latency information associated with the application server instances, wherein the protocol latency information is associated with at least one communication protocol of at least one communication layer below the application layer.

2. The apparatus of claim 1, wherein the processor is configured to:
identify the application with which the application processing request is associated; and
identify the application server instances of the application with which the application processing request is associated.

3. The apparatus of claim 1, wherein the protocol latency information associated with the application server instances comprises protocol latency information associated with a plurality of operating systems hosting the respective plurality of application server instances.

4. The apparatus of claim 1, wherein the protocol latency information comprises, for at least one of the application protocol instances, a protocol latency measurement associated with a protocol message exchange of an operating system hosting the application server instance.

5. The apparatus of claim 4, wherein the processor is configured to determine the protocol latency measurement as a difference between a time at which a protocol message to sent toward the operating system and a time at which a protocol response message is received from the operating system

6. The apparatus of claim 5, wherein the communication protocol is a Transmission Control Protocol (TCP), wherein the protocol message is a TCP SYN message and the protocol response message is a TCP SYN+ACK message.

7. The apparatus of claim 1, wherein, for at least one of the application protocol instances, a portion of the protocol latency information associated with the application protocol instance is based on a plurality of protocol latency measurements associated with a respective plurality of protocol message exchanges of an operating system hosting the application server instance.

8. The apparatus of claim 7, wherein the plurality of protocol message exchanges comprises at least one of:
a first protocol message exchange of a first protocol message exchange type and a second protocol message exchange of a second protocol message exchange type, wherein the protocol message exchange and the second protocol message exchange are associated with a first communication protocol of the at least one communication protocol;
a first protocol message exchange associated with a first communication protocol of the at least one communication protocol at a first communication layer of the at least one communication layer, and a second protocol message exchange associated with a second communication protocol of the at least one communication protocol at the first communication layer of the at least one communication layer; or
a first protocol message exchange associated with a first communication protocol of the at least one communication protocol at a first communication layer of the at least one communication layer, and a second protocol message exchange associated with a second communication protocol of the at least one communication protocol at a second communication layer of the at least one communication layer.

9. The apparatus of claim 8, wherein the processor is configured to determine the plurality of protocol latency measurements by:
initiating a protocol latency measurement for every N-th protocol message exchange of an operating system hosting the application server instance.

10. The apparatus of claim 9, wherein the processor is configured to determine each N-th protocol message exchange by the operating system based on protocol message exchanges of one or more protocol message exchange types of the one or more communication protocols of the one or more communication layers below the application layer.

11. The apparatus of claim 1, wherein, for at least one of the application server instances, the protocol latency information associated with the application server instance comprises at least one of:
a most recent protocol latency measurement for a protocol message exchange of an operating system hosting the application server instance;
a maximum protocol latency measurement from a plurality of protocol message exchanges of an operating system hosting the application server instance; or
an average protocol latency measurement based on a plurality of protocol message exchanges of an operating system hosting the application server instance.

12. The apparatus of claim 1, wherein the plurality of application server instances are hosted by a respective plurality of operating systems, wherein, for at least one of the operating systems, the processor is configured to:
determine operating system performance information associated with the operating system based on a portion of the protocol latency information that is associated with the application server instance hosted by the operating system.

13. The apparatus of claim 1, wherein, for at least one of the application server instances, the processor is configured to:
determine application server instance performance information associated with the application server instance based on a portion of the protocol latency information that is associated with the application server instance.

14. The apparatus of claim 1, wherein the plurality of application server instances are hosted by a respective plurality of operating systems which are hosted by a respective plurality of virtual machines, wherein, for at least one of the virtual machines, the processor is configured to:
determine virtual machine performance information associated with the virtual machine based on a portion of the protocol latency information that is associated with the application server instance hosted by the operating system hosted by the virtual machine.

15. The apparatus of claim 1, wherein the plurality of application server instances are hosted by a respective plurality of operating systems which are hosted by a respective plurality of virtual machines which are hosted by one or more host computers, wherein, for at least one of the one or more host computers, the processor is configured to:
determine host computer performance information associated with the host computer based on a portion of the protocol latency information that is associated with the application server instance hosted by the operating system hosted by the virtual machine hosted by the host computer.

16. The apparatus of claim 1, wherein the processor is configured to:
propagate the application processing request toward the selected one of the application server instances.

17. The apparatus of claim 1, wherein the at least one communication layer below the application layer comprises at least one of a presentation layer, a session layer, a transport layer, a network layer, a data link layer, or a physical layer.

18. The apparatus of claim 1, wherein the apparatus is a load balancer for a distributed virtual environment.

19. A computer-readable storage medium storing instructions which, when executed by a computer, cause the computer to perform a method, the method comprising:
receiving an application processing request for an application having a plurality of application server instances associated therewith, wherein the application is at an application layer; and
selecting one of the application server instances to which to provide the application processing request based on protocol latency information associated with the application server instances, wherein the protocol latency information is associated with at least one communication protocol of at least one communication layer below the application layer.

20. A method, comprising:
using a processor and a memory for:
receiving an application processing request for an application having a plurality of application server instances associated therewith, wherein the application is at an application layer; and
selecting one of the application server instances to which to provide the application processing request based on protocol latency information associated with the application server instances, wherein the protocol latency information is associated with at least one communication protocol of at least one communication layer below the application layer.
